(19) United States
(12) Patent Application Publication
(10) Pub. No.: US 2009/0001644 A1
(43) Pub. Date: Jan. 1, 2009

(54) Relocating Device Having at Least One Pilot Pin

(76) Inventors: Karl Hinderer, Fichtenberg (DE); Paul Skljarow, Schwieberdingen (DE)

Correspondence Address: MICHAEL J. STRIKER, 103 EAST NECK ROAD, HUNTINGTON, NY, 11743, US

(21) Appl. No.: 12/097,802

(22) PCT Filed: Dec. 20, 2006
(86) PCT No.: PCT/DE2006/002283

§ 371 Date: Jun. 17, 2008

(30) Foreign Application Priority Data
Jan. 16, 2006 (DE) 102006002000.6

(51) Int. Cl. B23Q 1/64

(52) U.S. Cl. 269/56

(57) ABSTRACT

A relocating device for a flexible processing line is embodied for relocating a workpiece holder (56) from a first workpiece holder position to a second workpiece holder position, different from the first, having at least one pilot pin (68), which extends along a pin axis (S) and is adjustable between a nonengagement position, in which it is out of engagement with a workpiece holder (56), and an engagement position, in which it is in engagement with a workpiece holder (56), and the pilot pin (68) has a pilot pin body (78) as well as a first support face (84) and a second support face (86), which extend in the axial direction and the circumferential direction relative to the pin axis (S) and point in the radial direction and are located remote in the radial direction from the pilot pin body (78) and are embodied for contact with counterpart support faces (70a) of an engagement recess (70), and the first support face (84) and the second support face (86) are embodied at least in some portions in different axial regions and different circumferential regions of the pilot pin (68).

The present invention relates to a relocating device, which is embodied for relocating a workpiece holder from a first workpiece holder position to a second workpiece holder position, different from the first, having at least one pilot pin, which extends along a pin axis and is adjustable between a nonengagement position, in which it is out of engagement with a workpiece holder, and an engagement position, in which it is in engagement with a workpiece holder.

Such relocating devices can be used for instance in flexible processing lines. Flexible processing lines, on which a plurality of individual processing stations can be disposed one after the other in a material flow direction, are known for instance from the field of small-part assemblies. In these processing lines, the workpieces to be processed are as a rule transported on uniform workpiece holders. A substantial contribution to the flexibility of the processing lines is made by the relocating devices, which are embodied for relocating a workpiece holder between two different positions, such as between two transportation paths or between one transportation path and a processing nest, and the like.

In adjusting the pilot pin between its nonengagement position and its engagement position, the pilot pin is as a rule introduced along its pin axis in the introduction direction into a suitable engagement recess on the workpiece holder. Analogously to this, in its adjustment from its engagement position to the nonengagement position, the pilot pin is moved along its pin axis in an withdrawal direction opposed to the introduction direction. During the introduction or withdrawal motion, unwanted seizing can occur between the pilot pin and the workpiece holder. This seizing can lead either to not bringing about any useful engagement between the pilot pin and the workpiece holder, or of not completely undoing an existing engagement between them. It can also happen that the workpiece holder, because of the clamping forces, is undesirably moved in an unpredictable direction, so that under some circumstances, a worker may have to intervene to make a correction by hand in order to restore the functioning of the relocating device at the applicable point.

It is therefore the object of the present invention to furnish a relocating device of the generic type in question, in which the risk of seizing between the pilot pin and the workpiece holder is reduced, compared to the prior art.

According to the invention, this object is attained by a relocating device of the type defined at the outset, in which the pilot pin includes a pilot pin body, on which a first radial protrusion and a second radial protrusion are embodied, and the first protrusion has a first support face, and the second protrusion has a second support face, which are embodied for contact with counterpart support faces of an engagement recess, and the first support face and the second support face are embodied at least in some portions in different axial regions and different circumferential regions of the pilot pin.

By the embodiment according to the invention of the pilot pin, in the engaged state of the workpiece holder and the pilot pin, there is play between the wall, oriented toward the pilot pin, of an engagement recess, into which the pilot pin is introduced, and the pin body. As a result of this play, the risk of seizing of the workpiece holder and pilot pin can be reduced.

The pilot pin rests with its first and second support faces on corresponding counterpart support faces of the engagement recess of the workpiece holder, so that by way of this contact engagement, forces can be transmitted.

Since the support faces are embodied in at least some portions in different axial regions and different circumferential regions of the pilot pin, the pilot pin does not rest at any point along its entire circumference, over its entire introduced depth, on the engagement recess. As a result, there is room for microscopic motions resulting from elasticities of the material, which act as escape motions. As a result, seizing can be lessened or even completely reduced.

In principle, the pilot pin can have an arbitrary cross-sectional shape, for instance as an arbitrary prism. Preferably, however, it is embodied cylindrically for engagement with a likewise cylindrical engagement recess. In this preferred case, the first and second support faces are embodied as cylindrical segments. Advantageously, the support faces are then shaped in such a way that refer to the pin axis, they extend in the axial direction and in the circumferential direction and point in the radial direction.

A face should be understood in terms of the present application as pointing in a certain direction when its normal vector has a component pointing in that direction.

Preferably, the relocating device described here is a so-called lifting-rotating relocating device, which after being put into operation lifts the workpiece holder and by pivoting relocates it in a new position. Preferably, the lifting of the workpiece holder takes place along the pin axis, since then the weight of the workpiece holder can be accepted by a device specifically embodied for this of the relocating device, and the pilot pin with its first and second support faces has to withstand only a tilting moment of the workpiece holder about an axial tilt axis extending between the first and second support faces, orthogonally to the pin axis. This can be done especially simply if the first and second support faces are embodied on opposite sides of the pin axis.

Seizing between the workpiece holder and the pilot pin can be avoided especially securely if the first support face and the second support face are embodied spaced apart from one another in the axial direction and/or in the circumferential direction, since then, the first and second support faces do not overlap in the axial direction and/or in the circumferential direction.

For avoiding or at least reducing a risk of seizing, it is also advantageous if the first and second support faces extend over as slight as possible an angular range in the circumferential direction. Advantageously, the first and second circumferential directions should extend over less than 180°, and especially preferably less than 120°, since then once again the largest possible free space remains between the pilot pin body and the engagement recess and can be used for the escape motion of the pilot pin.

To facilitate the introduction motion of the pilot pin into the engagement recess of the workpiece holder, it can be provided that at least between the introduction-side axial end of the first support face and/or second support face and the pilot pin body, an introduction ramp extending in the introduction direction is provided. Preferably, such introduction ramps are provided for both the first and the second support face. To further facilitate the introduction of the pilot pin into the engagement recess, the transition between the support face and the introduction ramp can be rounded.

For further simplifying the introduction motion of the pilot pin into the engagement recess of the workpiece holder, it can be provided that the pilot pin, on its introduction-side longitudinal end, is embodied with an introduction chamfer, in particular a conical introduction portion.

Especially simple introduction of the pilot pin into the engagement recess of the workpiece holder, with economical production of the pilot pin, can be accomplished if the introduction chamfer of the pilot pin and the introduction ramp of the support face located closer to the introduction-side longitudinal end of the pilot pin are embodied at least in some portions as a continuously coherent surface in the introduction direction.

In addition, seizing, as noted already above, can also occur in the withdrawal motion. To avoid or reduce this risk of seizing, the pilot pin can be embodied such that between the support face located closer to the introduction-side longitudinal end of the pilot pin and the pilot pin, and preferably between both support faces and the pilot pin, an withdrawal ramp extending in the withdrawal direction is embodied. An withdrawal ramp on the support face located farther from the introduction-side longitudinal end can often be dispensed with, if this support face is located on the axial end of the introduction path of the pilot pin, so that the trailing axial end in terms of the introduction direction of this support face does not plunge at all, or compared with the total introduction depth plunges only slightly, into the engagement recess of the workpiece holder. Once again, to facilitate the withdrawal motion, the transition between the support face and the withdrawal ramp can be rounded.

Also to avoid seizing from rotation, which might occur, of the workpiece holder on the pilot pin about the pin axis, it can be provided that between at least one circumferential end, and preferably both circumferential ends, of the first support face and/or the second support face and the pilot pin body, a ramp extending in the circumferential direction is provided. This ramp, in the case of cylindrical pilot pin bodies, can be embodied simply as a tangential face from the circumferential end to the cylindrical jacket face of the pilot pin body.

In the event of damage or retrofitting, the pilot pin can very easily be replaced with a new or different pilot pin, if, on its longitudinal end axially opposite the introduction-side longitudinal end, it has an insertion geometry for insertion into a counterpart insertion geometry of a pilot pin receptacle of the relocating device.

Preferably, the insertion geometry extends along an insertion axis, so that the pilot pin can easily be withdrawn from a pilot pin receptacle and inserted into it. For withstanding the aforementioned tilting moments at the relocating device, it is advantageous if the insertion axis is colinear with or at least parallel to the pin axis. In the preferred case of parallelism of the insertion axis and pin axis, the insertion axis is preferably offset toward a circumferential portion of the pilot pin where no support face is provided, so that the insertion end of the pilot pin, with the eccentrically located insertion geometry, can be inserted into corresponding recesses with parallel recess axes. As a result, the pilot pin can be secured in form-locking fashion by very simple means against rotation about its pilot pin axis. Moreover, the greatest possible spacing between two pilot pins of one device can thus be attained.

In a refinement of the present invention, the insertion geometry can include a securing geometry, such as a peg, or a recess for a bayonet mount in cooperation with the insertion geometry, or a thread. In principle, the pilot pin can be embodied on its introduction-side longitudinal end with a tool grasping geometry, such as a longitudinal slot or a crosswise slot or the like, in order to secure the pilot pin on the relocating device with the aid of a tool.

To shorten the setup times upon changing a pilot pin on the relocating device, the insertion geometry can be embodied on its insertion-side longitudinal end with an insertion slope, opposite the introduction-side longitudinal end, preferably in the form of a conical portion. The insertion geometry can then be threaded into the counterpart insertion geometry more easily and faster.

For secure fixation of the workpiece holder, the relocating device preferably includes a plurality of pilot pins. At least two pilot pins can be combined into a jointly adjustable pilot pin assembly. To permit overtaking procedures along transportation paths of the processing line, it is moreover advantageous if the pilot pins or pilot pin assemblies, in one and the same relocating device, are adjustable independently of one another between their nonengagement position and their engagement position.

The present invention will be described below in further detail in conjunction with the accompanying drawings.

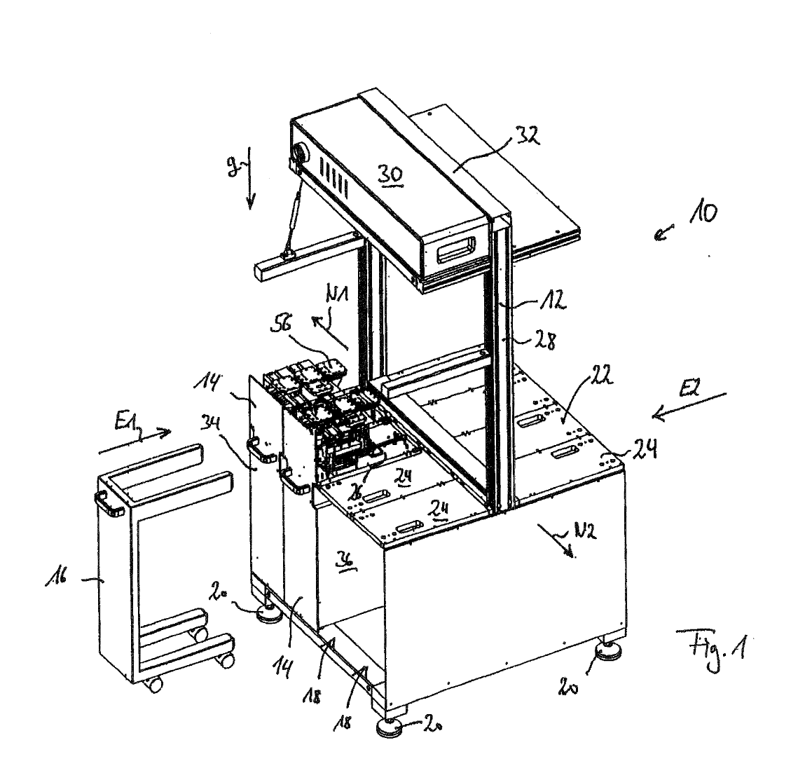

FIG. 1 shows a processing station of a processing line, on which an embodiment according to the invention of a workpiece holder is used;

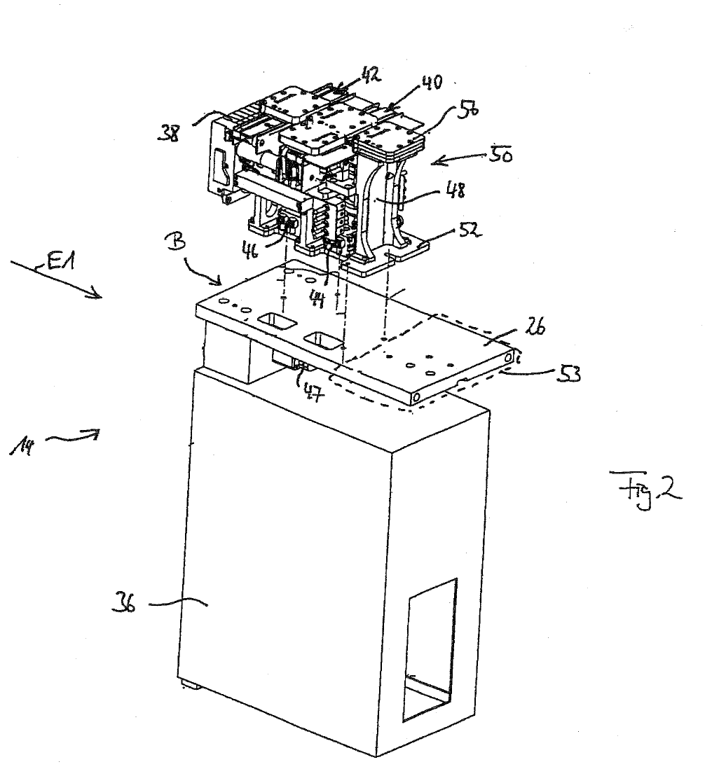

FIG. 2 shows a withdrawable module with transporting devices and a processing nest of the processing station of FIG. 1;

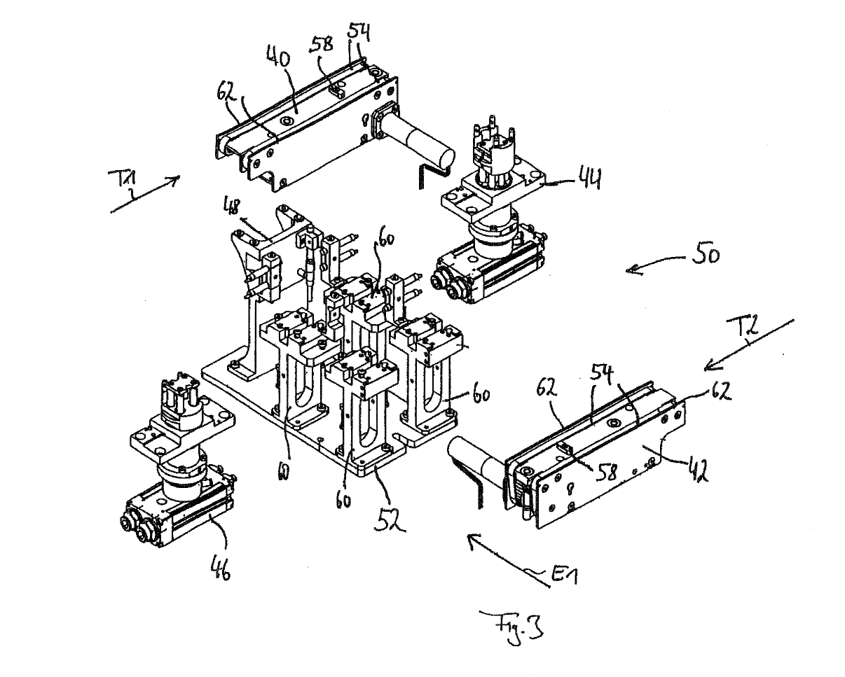

FIG. 3 shows a perspective exploded view of a structural unit comprising a transporting device, workpiece holder relocating devices and a processing nest of the withdrawable module of FIG. 2;

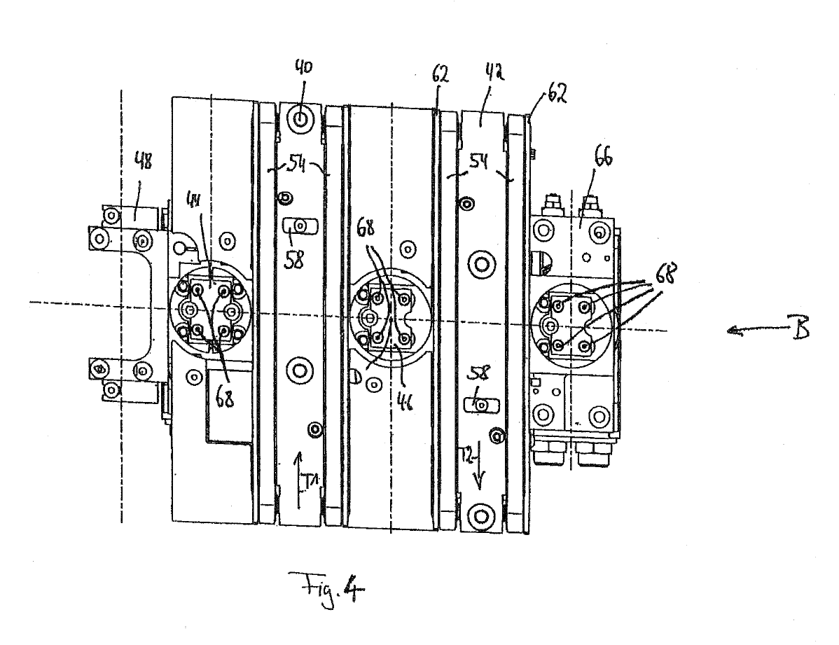

FIG. 4 shows a top view on the unit of FIG. 3;

FIG. 5 shows a perspective view of a relocating device which is in engagement with an embodiment according to the invention of a workpiece holder;

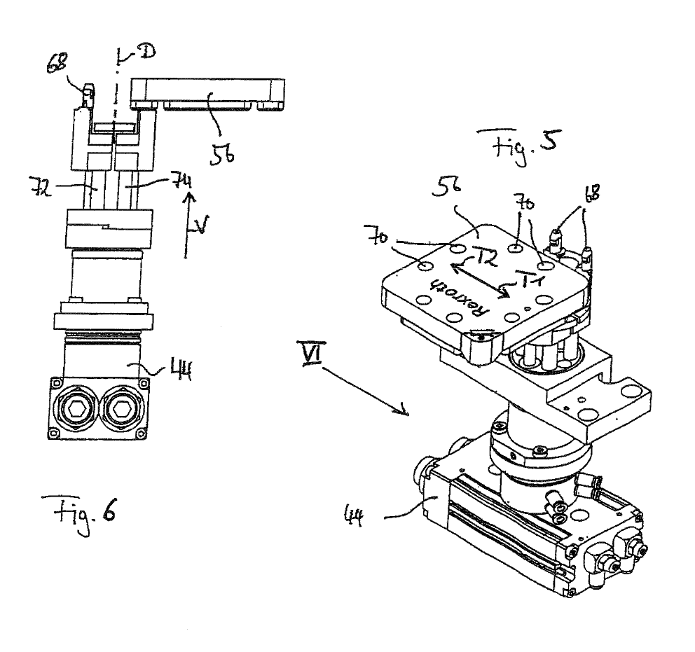

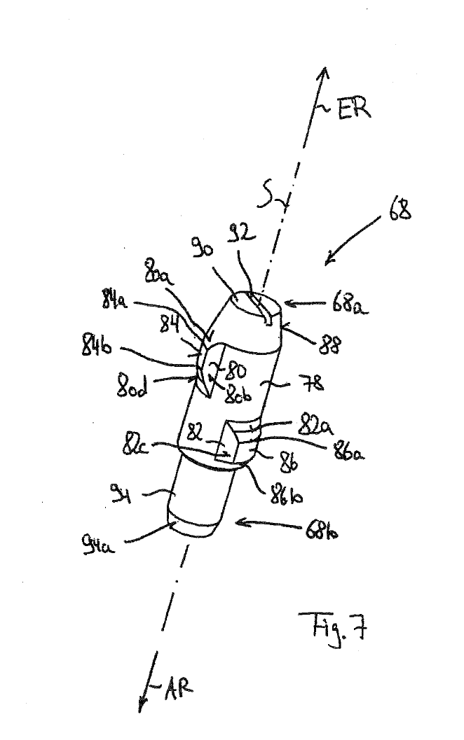

FIG. 6 shows a front view of the relocating device with the workpiece holder of FIG. 5;

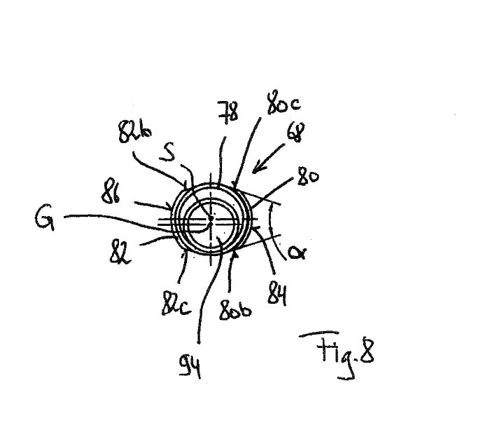

FIG. 7 shows a perspective view of one embodiment of a pilot pin according to the invention;

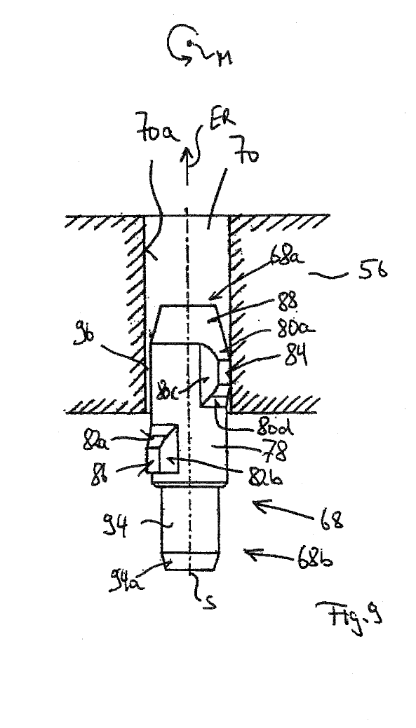

FIG. 8 shows a view of the pilot pin of FIG. 7 along the insertion axis and the pin axis from its insertion end; and

FIG. 9 shows the pilot pin of FIGS. 7 and 8 during an introduction motion into a workpiece holder.

In FIG. 1, a view according to the invention is shown of a processing station identified in general by reference numeral 10.

The processing station 10, which may be a component of a processing line, not shown, serves to process and handle workpieces, for instance for assembling small equipment, such as power drill gears, and the like. The processing station 10 includes a framework 12, which serves as a module platform, into which withdrawable modules 14 can be inserted in a first insertion direction E1. For that purpose, a withdrawable module 14 is placed with an auxiliary cart 16 in front of the desired module receptacle 18 and is then inserted into the module platform 12 in the first insertion direction E1.

The module platform 12 is constructed such that four withdrawable modules 14 can be inserted side by side in the first insertion direction E1 into the module platform, and four further withdrawable modules on the opposite side of the module platform 12 can be inserted into the module platform in a second insertion direction E2. The insertion directions E1 and E2 are opposed to one another.

The module platform 12 rests on adjustable-feet 20, so that a bottom face 22 of the module platform can be aligned with respect to the direction g of gravity, preferably in such a way that the bottom face 22 is “in the water”.

The bottom face 22 is formed of a total of eight flat base plates 24, all of which together form a common support plane. Each base plate 24 is assigned to one module receptacle 18.

The withdrawable modules 14 include module base plates 26, which rest essentially flatly on the base plate 24 whenever the withdrawable module 14 has been inserted into the module platform 12.

The module platform 12, on an upper framework 28 protruding past the bottom face 22, has a switchbox 30, which includes a control/regulating device, which communicates with the withdrawable modules 14 when they have been inserted into the module platform 12. A cable conduit 32, extending across the width of the module platform 12, is furthermore provided, in which supply and data transmission lines for a processing line can be located.

In the direction of the arrows N1 and N2 next to the processing station 10, further identical or similar processing stations can be provided, for forming a processing line.

In FIG. 2, a perspective exploded view of the withdrawable module 14 is shown; the plate 34 toward the operator (see FIG. 1) has been left out, for the sake of simplicity.

The withdrawable module 14 includes a control housing 36, in which control/regulating units can be received, which can be embodied for controlling processing and/or handling devices, not shown, that can be located on the module base plate 26. The control/regulating units provided in the control housing 36 can also be embodied for triggering a valve island 38, a first transportation path 40, and a second transportation path 42, and for controlling a process relocating device 44 and a transportation path relocating device 46. The control/regulating units can be connected to the switchbox 30 and the control/regulating device provided in it via a hybrid male plug 47, which, whenever the withdrawable module 14 has been inserted into the module platform 12, is inserted into a hybrid female plug, not shown, that is provided on the module platform 12. The valve island 38, the transportation paths 40, 42, and the relocating devices 44, 46 can alternatively, via a male electrical plug, also be connected directly to the control/regulating device in the switchbox 30 without the intermediate placement of a control/regulating unit in the control housing 36.

The hybrid male plug 47 includes a male electrical plug for power cords and data transmission lines and a male pneumatric plug, which on insertion of the withdrawable module 14 into the module platform 12 forms a plug connection with a female pneumatric plug, provided in the hybrid female plug of the module platform 12, for carrying compressed air as far as the valve island 38. There, depending on the triggering of the pneumatic switching valves located in the valve island 38, the compressed air can be carried selectively onward.

The valve island 38, the transportation paths 40 and 42, the relocating devices 44 and 46 (see also FIG. 3), and a processing nest 48 are mounted as a preassembled structural unit 50 on the module base plate 26. The preassembled structural unit 50, for that purpose, includes a common structural unit base plate 52, which carries the components of the preassembled structural unit 50.

The preassembled structural unit 50 is mounted on the module base plate 52 in such a way that the valve island 38 is placed closer to the operator side B of the withdrawable module 14. As a result, any oily waste air from the pneumatic switching valves of the valve island 38 can be prevented from reaching processing and/or handling devices that can be located downstream, in terms of the insertion direction E1, from the processing nest 48. For their placement, a processing region 53, indicated by dashed lines, is reserved on the module base plate 26. To facilitate the placement of such processing and/or handling devices, bores and/or holes and/or grooves can be provided in the module base plate 26.

In FIG. 3, the preassembled structural unit 50 is shown in an exploded view. The valve island 38 has been left out of the view in FIG. 3.

The first transportation path 40 and the second transportation path 42 are constructed essentially identically and are formed by a double-belt conveyor device. To that end, the second transportation path 42, which in this description represents the first transportation path 40 as well, includes two parallel belt conveyor belts 54 spaced apart from one another. The second transportation path 42 is provided for moving workpiece holders 56 (see FIG. 1 or FIG. 2) in a second transporting direction T2. Accordingly, the first transportation path 40 is embodied for conveying workpiece holders in the opposite, first transporting direction T1.

The second transportation path 42, like the first transportation path 40, includes a stop 58 that is selectively adjustable between a stop position and an open position, which in the extended state acts as a stop for workpiece holders conveyed on the transportation paths 40 and 42 and in the retracted state is run over by these workpiece holders.

Like the processing nest 48, various individual holders 60 are screwed onto the structural unit base plate 42. The holders 60 serve to receive the transportation paths 40 and 42 and the relocating devices 44 and 46. In an advantageous refinement, not shown, of the present invention, the four individual holders 60 can also be combined into one integral holder arrangement.

By means of the arrangement shown in FIG. 3, the transportation paths 40 and 42, the relocating devices 44 and 46, and the processing nest 48 can be aligned ideally with one another, before the withdrawable module 14 that holds the structural unit 50 is inserted into a module platform 12.

The relocating device 46 shown in FIG. 3 is a transportation path relocating device, which is embodied for relocating workpiece holders 56 from the first transportation path 40 to the second transportation path 42 and vice versa. To that end, the relocating device 46 lifts the workpiece holder on a transportation path until the workpiece holder 56 becomes disengaged from the guide strips 62 of the transportation paths 40 and 42. Then, the relocating device 46 pivots the workpiece holder 1800 and sets it down between the guide strips 62 of the respective other transportation path. It follows that the transportation paths 40 and 42 are located at a spacing from one another that is determined by the size of the workpiece holder 56, and the axis of rotation of the relocating device 46 is located in the middle, spaced apart by the same distance from each of the transportation paths 40 and 42.

The relocating device 44 is conversely a process relocating device, which is embodied for relocating workpiece holders from the first transportation path 40 to the processing nest 48 and vice versa. As a result, a workpiece holder can be taken from the transportation path and processed at the processing nest 48 by processing and/or handling devices, regardless of transporting operations taking place on the first transportation path.

In FIG. 4, a top view is shown onto the first and second transportation paths 40, 42, the process relocating device 44, the transportation path relocating device 46, and the processing nest 48. A third relocating device 66 is also shown, which is capable of pivoting a workpiece holder, not shown, from the second transportation path 42 to the side pointing away from the processing nest 48, or in other words toward the operator side B. Each of the relocating devices 44, 46, 66 has a total of four pilot pins 68, which engage the workpiece holder in order to relocate it. The pins 68 are essentially identical and are merely located with a different orientation on the various relocating devices.

For relocating a workpiece holder, only two of four pilot pins 68 of one relocating device each engage corresponding recesses 60 (see also FIG. 5) in the workpiece holder 56. Pilot pins 68 spaced apart from one another in the transporting direction T1 and T2 always form such engagement pairs. The axis of rotation of the transportation path relocating device 46 is marked D in FIG. 4. It is orthogonal to the plane of the drawing in FIG. 4. The axis of rotation D has the same spacing from the first transportation path 40 as from the second transportation path 42. A workpiece holder moved by the transportation paths 40 and 42 must be at least wide enough that the pairs of pilot pins 68 located closer to the particular transportation path on which the workpiece holder is being moved are capable of engaging the workpiece holder. In order that the workpiece holder 56 can be grasped selectively both by the transportation path relocating device 46 and by the process relocating device 44 or the third relocating device 46 (depending on which transportation path it is located on), the workpiece holder preferably protrudes to both sides of the transportation paths 40 and 42 past the transportation paths by a suitable amount.

With the transportation path relocating device 46 located in the middle between the first and second transportation paths 40 and 42, the process relocating device 44 is located in the middle of the spacing between the processing nest 48 and the first transportation path 40.

So that the orientation of a workpiece holder 56 on the transportation paths 40, 42 will not be critical, preferably essentially symmetrical workpiece holders 56 with a square outline will be used, which have recesses 70 on each side for engagement by the pilot pins 68.

It will be noted that the axes of rotation D of all the relocating devices 44, 46 and 66 in FIG. 4 all have the same spacing from the respective closest associated transportation path.

In FIG. 5, the process relocating device 44 is shown in perspective. The process relocating device 44 in FIG. 5 is in engagement with the workpiece holder 56 having the substantially square outline. The recesses 70 for engagement by the pilot pins 68 of the process relocating device 44 can be seen.

In FIG. 6, a front view in the direction of the arrow VI in FIG. 5 is shown of the process relocating device 44.

The relocating devices 44, 46 and 66 used in the example shown are so-called lifting-rotating units, which after grasping a workpiece holder 56 lift it in the direction of the arrow V along its axis of rotation D and pivot it by 180° about this axis of rotation D. For lifting workpiece holders 56, the process relocating device 44 has two lifting systems 72 and 74, actuatable separately from one another, which assures that a workpiece holder received in the processing nest 48 can be grasped and lifted by one of the lifting devices 72 or 74, without the other lifting device being raised as well and thus protruding into the path of motion of a workpiece holder that is moving along the first transportation path 40. This assures that the transporting function of the transportation path 40 is preserved, regardless of whether a workpiece holder is located in the processing nest 48 or not. As a result, workpiece holders from the transportation path 40 can pass a workpiece holder received in the processing nest 48.

In FIG. 7, an embodiment of a pilot pin 68 is shown. The pilot pin 68 extends along its pin axis S, which simultaneously defines the introduction direction ER of the pilot pin 68 into an engagement recess 70 of the workpiece holder 56.

The pilot pin 68 has a substantially cylindrical pilot pin body 78 and two protrusions 80 and 82 protruding radially from the pilot pin body. On the protrusions 80 and 82, support faces 84 and 86, concentric with the cylindrical jacket face of the pilot pin body 78, are embodied as cylindrical segment faces with the pin axis S as their center axis. These support faces 84 and 86 are embodied for contact with counterpart support faces 70a of the engagement recesses 70 of workpiece holders 56 (see FIG. 9).

On its introduction-side longitudinal end 68a, the pilot pin 68 has a conical introduction chamfer 88, which facilitates the introduction of the pilot pin 68 into the engagement recess 70 of the workpiece holder 56. On the face end 90 of the introduction-side longitudinal end 68a of the pilot pin 68, a slot 92 is provided for engagement by a screwdriver. A screwdriver, not shown, can engage it here, for instance, in order to screw the pilot pin 68 into a relocating device.

The protrusions 80 and 82 have introduction ramps 80a and 82a pointing in the introduction direction ER, and the introduction ramp 80a of the protrusion 80 located closer to the introduction-side longitudinal end 68a merges continuously with the introduction chamfer 88 of the pilot pin 68. The introduction ramps described facilitate the introduction of the support faces 84 and 86 into the corresponding engagement recess 70 on the workpiece holder 56.

The introduction ramp 80a, with the introduction-side axial end 84a of the support face 84, forms a rounded step. The introduction ramp 82a likewise forms a rounded step with the introduction-side axial end of the support face 86.

Tangential faces are also provided, which extend tangentially from the circumferential ends of the respective support faces 84 and 86 to the cylindrical pilot pin body 78. In FIG. 7, the tangential faces 80c and 82b can be seen on the respective protrusions 80 and 82. In FIG. 8, all the tangential faces 80b, 80c, 82b, 82c, which likewise form ramps, can be seen.

The protrusion 80 also has an withdrawal ramp 80d, pointing in an withdrawal direction AR opposed to the introduction direction ER. The withdrawal ramp 80d extends between the axial end 84b, closer to the insertion end 68b of the pilot pin 68, of the support face 84 and the cylindrical jacket face of the pilot pin body 68.

On the support face 86 located closer to the insertion end 68b, there is no such withdrawal ramp, since the axial end 86b, located closer to the insertion end 68b, of the support face 86, compared to the total penetration depth of the pilot pin 68 into the engagement recess 70, plunges to only a slight distance or not at all into the engagement recess 70 of the workpiece holder 56. Already at the onset of the withdrawal motion of the pilot pin 68 from the engagement recess 70, the axial end 84b located closer to the insertion-side longitudinal end 68b of the pilot pin 68 becomes disengaged from the engagement recess 70, so that here, an withdrawal ramp facilitating the withdrawal of the applicable support face 84 can be dispensed with.

The transitions between the support faces 84 and 86 and the adjoining ramps 80a, 80b, 80c, 80d, and 82a, 82b, 82c, 82d, respectively, are rounded, to avoid unwanted seizing.

In FIG. 8, it can be seen that the tangential faces 80b and 80c of the radial protrusion 80 located closer to the introduction-side longitudinal end 68a form an angle α. The tangential faces 82b and 82c of the radial protrusion 82 located closer to the insertion end 68b of the pilot pin 68 likewise form an angle. Preferably, the two angles are identical. To avoid high pressures per unit of surface area, the angle α is preferably between 30° and 45°, especially preferably between 35° and 40°, and extremely advantageously between 35° and 36°.

As can be seen from viewing FIGS. 7 and 8 together, the support faces 84 and 86 are on different sides relative to the pilot pin axis S and in neither the axial direction nor the circumferential direction do they extend so far that they occupy common axial or circumferential regions of the pilot pin 68; that is, neither when viewed in an axial projection (along the pilot pin axis S) in the circumferential direction nor in a radial projection in the axial direction do the support faces 84 and 86 overlap. However, this should not preclude the possibility that the introduction ramp 82a and the withdrawal ramp 80d overlap in the axial direction when viewed in radial projection.

The pilot pin 68 shown here has the advantage that it rests with only the two support faces 84 and 86 on the inner wall 70a of an engagement recess 70. This means that viewed only in the aforementioned axial projection, the support faces 84 and 86 have a spacing from one another corresponding to the diameter of the engagement recess 70. However, each cross section of the pilot pin 68, essentially over the entire introduction depth, has a smaller cross-sectional area and a lesser diameter than the substantially cylindrical engagement recess 70 of the workpiece holder 56. As a result, the pilot pin 68 can execute at least slight escape motions within the engagement recess 70, thereby avoiding seizing during the introduction or withdrawal motion.

Because of the different position of the support faces 84 and 86 in the axial direction and the circumferential direction relative to the pilot pin axis S, tilting moments of the workpiece holder 56 held on the pilot pin 68 can be withstood at these support faces.

On its insertion-side longitudinal end 68b, the pilot pin 68 has a peg 94, which is likewise provided with a conical introduction chamfer 94a. In the example shown here, the peg 94 has a lesser diameter than the pilot pin body 78. The peg 94, which extends along a peg axis G (see FIG. 8) parallel to the pilot pin axis S, is located with a radial offset with respect to the pilot pin axis S. The offset direction is orthogonal to a plane defined by the pilot pin axis S and the normal vectors of the support faces 84 and 86. The pilot pin 68 is inserted into a corresponding stepped bore (not shown) by its insertion-side longitudinal end 68b and with a portion, near the peg 94, of the pilot pin body 78 and is thus secured in form-locking fashion against rotation about the pilot pin axis S.

Alternatively, the peg 94 may be embodied with a radial protrusion, for instance to achieve bayonet-mount locking. Instead of a radial protrusion, to implement the bayonet-mount locking, it may also provided with a corresponding L-shaped recess.

In FIG. 9, an introduction motion of the pilot pin 68 into a cylindrical engagement recess 70 of a workpiece holder 56 is shown. In FIG. 9, it can be seen that the pilot pin 68 rests only with the support faces 84 and 86 on the cylindrical inner wall as a counterpart support face 70a of the engagement recess 70 of the workpiece holder 56. Along the remainder of the introduction path, a gap space 96 remains between the inner wall of the engagement recess 70 and the pilot pin body 78. The location of the support faces 84 and 86 in the example shown in FIG. 9 permits the withstanding of a tilting moment M of the kind shown in FIG. 9. The moment vector of the tilting moment M is orthogonal to the plane of the drawing in FIG. 9.

Each of the support faces described above can also be embodied in multiple parts, or in other words with at least two partial support faces embodied separately from one another.

1. A relocating device, which is embodied for relocating a workpiece holder (56) from a first workpiece holder position to a second workpiece holder position, different from the first, having at least one pilot pin (68), which extends along a pin axis (S) and is adjustable between a nonengagement position, in which it is out of engagement with a workpiece holder (56), and an engagement position, in which it is in engagement with a workpiece holder (56),
characterized in that the pilot pin (68) includes a pilot pin body (78), on which a first radial protrusion (80) and a second radial protrusion (82) are embodied, and the first protrusion (80) has a first support face (84), and the second protrusion (82) has a second support face (86), which are embodied for contact with counterpart support faces (70a) of an engagement recess (70), and the first support face (84) and the second support face (86) are embodied at least in some portions in different axial regions and different circumferential regions of the pilot pin (78).

2. The relocating device with a pilot pin as defined by claim 1,
characterized in that the first support face (84) and the second support face (86) are embodied on opposite sides of the pin axis (S).

3. The relocating device with a pilot pin as defined by claim 1,
characterized in that the first support face (84) and the second support face (86) are embodied spaced apart from one another in the axial direction and/or in the circumferential direction.

4. The relocating device with a pilot pin as defined by claim 1,
characterized in that at least between the introduction-side axial end (84a, 88a) of the first support face (84) and/or second support face (86) and the pilot pin body (78), an introduction ramp (80a, 82a) extending in the introduction direction (ER) is provided.

5. The relocating device with a pilot pin as defined by claim 1,
characterized in that the pilot pin (68), on its introduction-side longitudinal end (68a), is embodied with an introduction chamfer (88), in particular a conical introduction portion.

6. The relocating device with a pilot pin as defined by claim 4,
characterized in that the introduction chamfer (88) of the pilot pin (68) and the introduction ramp (80a) of the support face (84) located closer to the introduction-side longitudinal end (68a) of the pilot pin (68) are embodied at least in some portions as a continuously coherent surface in the introduction direction (ER).

7. The relocating device with a pilot pin as defined by claim 1,
characterized in that between the support face (84) located closer to the introduction-side longitudinal end (68a) of the pilot pin (68) and the pilot pin (68), and preferably between both support faces (84, 86) and the pilot pin (68), an withdrawal ramp (80d) extending in the withdrawal direction (AR) is embodied.

8. The relocating device with a pilot pin as defined by claim 1,
characterized in that between at least one circumferential end, and preferably both circumferential ends, of the first support face (84) and/or the second support face (86) and the pilot pin body (78), a ramp (80b, 80c, 82b, 82c) extending in the circumferential direction is provided.

9. The relocating device with a pilot pin as defined by claim 1,
characterized in that the pilot pin (68), on its longitudinal end (68b) axially opposite the introduction-side longitudinal end (68a), has an insertion geometry (94) for insertion into a counterpart insertion geometry of a pilot pin receptacle of the relocating device (40, 42), and the insertion geometry (94) preferably extends along an insertion axis (G).

10. The relocating device with a pilot pin as defined by claim 9,
characterized in that the insertion axis (G) is parallel to the pilot pin axis (S), and it is preferably offset toward a support face-free circumferential region of the pilot pin (68).

11. The relocating device with a pilot pin as defined by claim 9,
characterized in that the insertion geometry (94) is embodied on its insertion-side longitudinal end with an insertion slope (94a), preferably in the form of a conical portion.

12. The relocating device with a pilot pin as defined by claim 1,
characterized in that it includes a plurality of pilot pins (68), and preferably at least two pilot pins (68) are combined into a jointly adjustable pilot pin assembly.
